(19) United States
(12) Patent Application Publication
(10) Pub. No.: US 2013/0110930 A1
(43) Pub. Date: May 2, 2013

(54) SOCIAL DATA MANAGEMENT SYSTEM AND METHOD FOR OPERATING THE SAME

(71) Applicant: Samsung Electronics Co., Ltd., Gyeonggi-do (KR)

(72) Inventors: Boseok MOON, Gyeonggi-do (KR); Sangho Yi, Seoul (KR); Sangbum Suh, Seoul (KR); Hyunjin Choi, Seoul (KR)

(73) Assignee: Samsung Electronics Co., Ltd., Gyeonggi-do (KR)

(21) Appl. No.: 13/665,512

(22) Filed: Oct. 31, 2012

(30) Foreign Application Priority Data
Oct. 31, 2011 (KR) 10-2011-0112334

(51) Int. Cl. G06F 15/16

(52) U.S. Cl. 709/204

(57) ABSTRACT

A social data management system and a method for operating the same capable of managing social data with respect to various social networking services based on a mobile platform through a social data management system in a mobile device are provided. A system for supporting a social networking service includes a plug-in manager for managing social data of the social networking service used by a user through a plug-in library structure; and a common characteristic processor for tracking an activity of the user based on use of an SNS of the user to extract a user interest keyword, extracting another user whose interest is similar and social contents, and automatically selecting social content preferred by the user, and giving a priority to the selected social contents.

### PRIORITY

This application claims priority under 35 U.S.C. §119(a) to a Korean patent application filed on Oct. 31, 2011 in the Korean Intellectual Property Office and assigned Serial No. 10-2011-0112334, the entire content of which is incorporated herein by reference.

### BACKGROUND OF THE INVENTION

1. Field of the Invention

The present invention relates generally to a social data management system in a mobile device, and more particularly, to a social data management system and a method for operating the same which processes various social data according to a Social Networking Service (SNS) using common characteristic of SNSs in the mobile device.

2. Description of the Related Art

Recently, with the increase in the supply of mobile devices such as smartphones or tablet Personal Computers (PCs), more users have been using mobile devices. In addition to the popularity of the mobile device, there is growing interest in the development of mobile applications. Specifically, a development scheme of mobile applications has changed in various ways based on changes in the environment of mobile platforms. Mobile platforms include hardware and/or software in mobile devices. The mobile device is a layered device including a hardware layer of an Integrated Circuit (IC) level being the lowest layer, a firmware and Operation System (OS) layer being a next layer, and an application program being the upper layer. The lowest layer of the mobile device refers to a platform. However, in general, designers of application programs refer to the hardware and software as the platform. The is so because the hardware and the software provide support for an application.

Recently, with the increase in the supply of mobile devices, various SNSs have been developed. The SNS is a service that allows users of user devices (particularly, mobile devices) accessing a wired or wireless Internet to share information and perform bilateral communication anytime and anywhere. That is, SNS is a community type online service capable of having a connection with unspecified persons, and indicates a concept including one-person media and information sharing. The SNS is provided in the various forms such as a bookmarking service and webpage saving service such as Read it Later, or Instapaper, or a location-based mobile service such as Foursquare as well as a community and blogging service such as Twitter, Myspace, Facebook, FriendFeed, Cyworld, or Me2 day. Further, with increased interest in SNSs, a form of an application for supporting the SNS varies. Specifically, recently, the SNS is combined with a mobile device to enable the SNS by using mobile access. Accordingly, various functions such as call, conference, shopping, communication, information, information search, email, and instant messenger service have been provided together with the SNS.

A mobile application developer includes and develops a library provided from an SNS enterpriser to collect and process various SNS data from the mobile application in the SNS. This will be described with reference to FIG. 1.

FIG. 1 is a diagram illustrating a platform structure including an application for supporting an SNS in a general mobile device.

Referring to FIG. 1, an enterpriser providing the SNS provides at least one library for a corresponding SNS to document commands that can be used with the corresponding SNS such that a user can use the commands in various platforms and to be shared by developers.

Accordingly, the developer of the mobile application needs to develop an application (e.g., a social application such as an A application, a B application, a C application) to support the SNS including respective libraries providing various SNS enterprisers associated therewith. That is, a social application developer needs to link a library of a corresponding SNS to support respective SNSs associated with an application to be developed. For example, as shown in FIG. 1, the social application developer needs to perform an operation of linking respective libraries supported from an enterpriser of each SNS (services such as Facebook, Twitter, Read it Later, Foursquare, FriendFeed, Instapaper) to a library with respect to at least one SNS based on a type of an application in developing respective applications. For example, to develop the A application (e.g., a Flipboard application, which is a type of magazine application, for supporting a magazine-based mobile SNS), the social application developer needs to develop respective libraries such as a Facebook library (Facebook Lib.), a Twitter library (Twitter Lib.), and a Read it Later Library (Read It Later Lib.) provided from various SNS enterprisers to be linked with one another. To develop the B application (e.g., a Waze application, which is a type of social map or social navigation application, for supporting a mobile SNS), the social application developer needs to develop respective libraries such as a Facebook library (Facebook Lib.), a Twitter Library (Twitter Lib.), and a Foursquare library (Foursquare Lib.) provided from various SNS enterprisers to be linked with each other. Further, in order to develop a C application (e.g., My6sense, which is a type of application allowing a user to search various SNSs, for supporting a search based mobile SNS, the social application developer needs to develop respective libraries such as a Facebook library (Facebook Lib.), a Twitter library (Twitter Lib.), a FriendFeed library (FriendFeed Lib.), and an Instapaper Library (Instapaper Lib.) provided from various SNS enterprisers to be linked with one another.

When developing the application, a social application developer also needs to implement functions such as content selection, User Preference Analysis, Content Ranking, and User Activity Tracking according to a support form of the SNS. For example, an application to be developed needs to be associated with a corresponding additional function according to whether it is an application for a magazine-based SNS, an application for a location-based SNS, or a search based SNS.

Accordingly, a developer of the mobile application may have problems as follows when developing an application processing data (i.e., social data) of various networking services. That is, as the developer develops the application including a plurality of libraries provided from the SNS enterpriser, the size of the application is increased and accordingly, the performance of a mobile device is deteriorated due to the increased use of memory and an increased amount of code. Further, it is difficult to implement an algorithm or a function for processing social data reflecting an additional function such as user preference information (e.g., contents, persons, interest keywords, etc.) or user activity track in the application itself. Accordingly, there is a problem in that it is difficult to display social content based on user preference information or user activity. For example, it is difficult for a user to find out user preference information such as content, users, or interest keywords from the application. Accordingly, when providing an SNS based on a corresponding application, the possibility that useless undesirable social data is display is increased.

### SUMMARY OF THE INVENTION

The present invention has been made in view of the above problems, and provides a social data management system and a method for operating the same capable of integrally managing social data of various SNSs in a mobile platform.

The present invention further provides a social data management system and a method for operating the same that supports various SNSs in a mobile platform to provide ease of application development for SNS.

The present invention further provides a social data management system and a method for operating the same that do not require connecting various libraries for supporting various SNSs when developing an SNS based application, and provide an application through a plug-in library structure in a mobile device, thereby making application development easier.

The present invention further provides a social data management system and a method for operating the same that supports common characteristics of various SNSs from a mobile device to process various SNSs according to an SNS.

The present invention further provides a social data management system and a method for operating the same that provides common characteristics of various SNSs from a mobile device and perform automatic ranking or filtering for social data which the user prefers.

In accordance with an aspect of the present invention, a method for supporting a social networking service is provided. The method includes determining the social networking service associated with an application when execution of the application is sensed; connecting libraries for supporting the social networking service in a plug-in form based on the application; and providing the social networking service based on the application

In accordance with another aspect of the present invention, a method for supporting a social networking service is provided. The method includes tracking a user activity when execution of an application is sensed from a user; extracting an interest keyword of the user; automatically ranking or filtering social data of social networking services associated with the user based on the extracted interest keyword; and providing the social networking service through the application.

In accordance with another aspect of the present invention, a computer-readable recording medium on which a program for executing the method in a processor is recorded is provided.

In accordance with another aspect of the present invention, a system for supporting a social networking service is provided. The system includes a plug-in manager for managing social data of the social networking service used by a user through a plug-in library structure; and a common characteristic processor for tracking an activity of the user based on use of an SNS of the user to extract a user interest keyword, extracting another user whose interest is similar and social contents, and automatically selecting social content preferred by the user, and giving a priority to the selected social contents.

### BRIEF DESCRIPTION OF THE DRAWINGS

The foregoing aspects, objects, features and advantages of the present invention will be more apparent from the following detailed description in conjunction with the accompanying drawings, in which:

FIG. 1 is a diagram illustrating a platform structure including an application for supporting an SNS in a general mobile device;

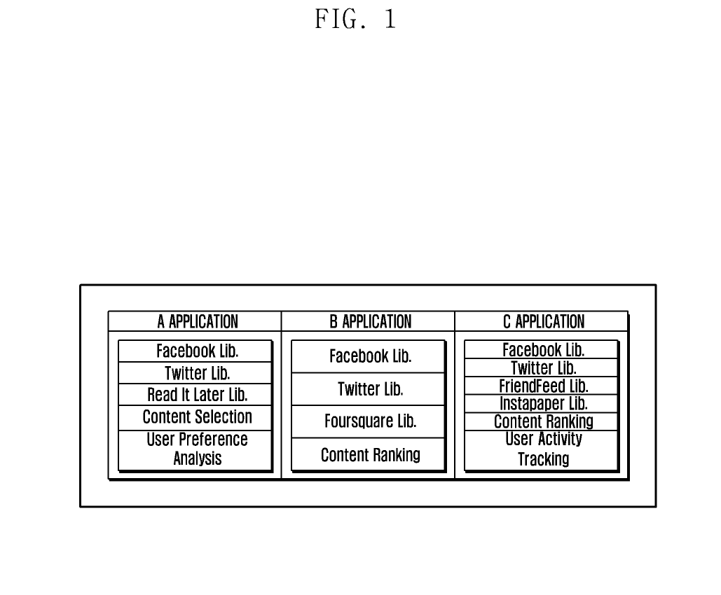

FIG. 2 is a block diagram illustrating a configuration of a mobile device according to an embodiment of the present invention;

FIG. 3 is a diagram illustrating a platform structure in which a social data management system for supporting an SNS in a mobile device is mounted according to an embodiment of the present invention;

FIG. 4 is a block diagram illustrating a configuration of a social data management system according to an embodiment of the present invention;

FIG. 5 is a flowchart illustrating a method for supporting an SNS of a mobile device according to an embodiment of the present invention; and

FIG. 6 is a flowchart illustrating a method for managing social data of a mobile device according to an embodiment of the present invention.

### DETAILED DESCRIPTION OF EMBODIMENTS OF THE PRESENT INVENTION

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

The present invention relates a system for managing social data in a mobile device supporting an SNS and a method for operating the same. In particular, an embodiment of the present invention supports common characteristics of various SNSs to process various social data according to the SNS by itself. The present invention provides ease in reducing the size of an application associated with the SNS and development thereof. Social content of user preference information based SNS may be exactly displayed. According to the present invention, because an SNS of a user is managed in the mobile platform itself, an application using social data may be easily developed by calling an Application Programming Interface (API) of the mobile platform. Further, although an application developer does not perform a separate processing, automatic ranking and filter processing for user preference social data is possible.

To do this, the present invention is implemented to include a configuration of managing data of various SNSs and automatically selecting and giving a preference to social content preferred by the user, a configuration of managing various SNSs in a plug-in form, a configuration of analyzing user activity in the mobile device to extract a user interest keyword, and a configuration of extracting user and social content whose interest is different using a user interest key word.

In an embodiment of the present invention, the common characteristics indicate a characteristic provided through respective SNSs such as a library, social data, social contents, a pattern according to use of an SNS of the user, interest keywords (field, genre), social interest keywords (other users, content types whose interest is different), or user preference information.

In an embodiment of the present invention, the activity includes content with respect to all activities (all activities generated based on use of the SNS) using a mobile device. For example, the activity includes content with respect to all activities using a device by the user such as execution of an application (particularly, an application associated with the SNS) in a mobile device, use and generation of contents, playback and viewing media contents, visiting profile pages of other users, selecting news contents, selecting electronic mail link, accessing communication (e.g., Near Field Communication (NFC)), watching digital broadcasting, watching news through web access.

Hereinafter, a configuration of a mobile device and a method for operating the same according to an embodiment of the present invention will be described with reference to the accompanying drawings.

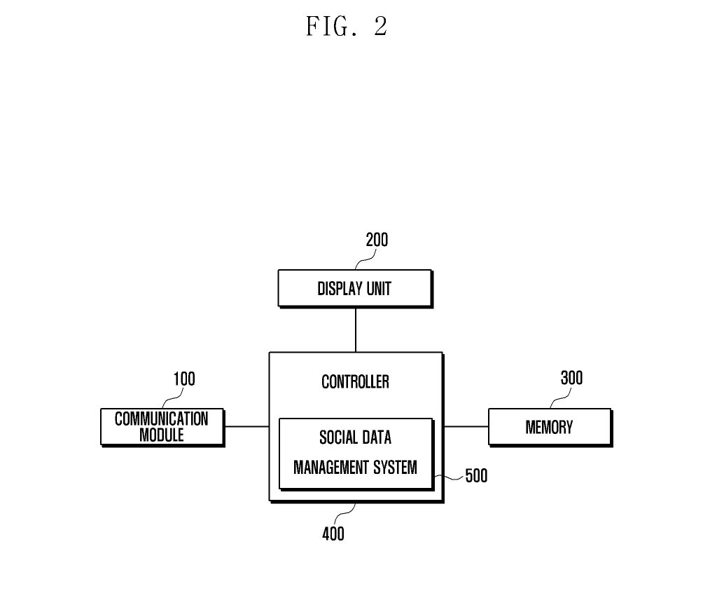

FIG. 2 is a block diagram illustrating a configuration of a mobile device according to an embodiment of the present invention.

Referring to FIG. 2, the mobile device of the present invention includes a communication module 100, a display unit 200, a memory 300, and a controller 400. The controller 400 also includes a social data management system 500. Additionally, the mobile device includes an audio processor with a microphone and a speaker, a digital broadcasting module for receiving digital broadcasting (e.g., mobile broadcasting such as Digital Multimedia Broadcasting (DMB) or Digital Video Broadcasting (DVB)), a camera module for photographing still images and moving images of a subject, at least one near distance communication module for supporting near distance wireless communication based communication function such as Bluetooth® communication, Infrared Data Association (IrDA) communication, Radio Frequency Identification (RFID) communication, or Near Field Communication (NFC), an input unit for supporting hard key based input, a touchscreen for supporting touch-based input, a location information collecting module for collecting location information for a location-based service, and a battery for supplying power to the foregoing structural elements, but a detailed description thereof is omitted.

The communication module 100 supports communication with an external server (e.g., SNS enterpriser server or the like) for SNS through a communication network or another mobile device. In the present invention, the communication module 100 includes a Radio Frequency (RF) module for supporting a communication function based on mobile communication. Further, the communication module 100 supports an Internet Protocol (IP) based Internet communication service. Particularly, when using the SNS in the mobile device, the communication module 100 receives social data from an external server or a mobile device or transmits social data corresponding to user input to the external server or the mobile device. Further, the communication module 100 is not limited to a certain communication module or communication scheme, but may be implemented by various types of communication modules that communicate with the external server or other mobile devices.

The display unit 200 displays a screen associated with an operation state of the mobile device. For example, the display unit 200 displays a menu screen of a mobile device or respective execution screens according to execution of various applications. Further, in the present invention, a Liquid Crystal Display (LCD) is generally used as the display unit 200, but other display devices such as a Light Emitting Diode (LED), an Organic LED (OLED), or an Active Matrix OLED (AMOLED) may be used. Moreover, in the present invention, the display 200 includes an interface supporting touch-based input. For example, the display unit 200 supports various user touch inputs by using a touchscreen, and generates an input signal according to user input and transfers the generated input signal to the controller 400. In the present invention, the display unit 200 displays a screen associated with use of an SNS of the user. Specifically, the display unit 200 displays a screen configured by social data processed by the mobile device with respect to an SNS based on a certain application.

The memory 300 stores various application and data executed and processed by the mobile device, and include at least one non-volatile memory and volatile memory. That is, the memory 200 includes at least one of a Read Only Memory (ROM), a flash memory, a Random Access Memory (RAM), an internal Hard Disk Drive (HDD), an external HDD, and an external storage medium. Further, the memory 300 continuously or temporarily stores an operating system of the mobile device, a program and data associated with a display control operation of the display unit 200, a program and data associated with an input control operation using the display unit 200, and a program and data associated with support of the SNS of the mobile device. Further, in the present invention, the memory 300 stores a DataBase (DB) based on user activity tracked when using an SNS of the user. Further, the memory 300 stores user preference information, keywords, ranking information, filtering information, and the like according to use of an SNS of the user.

The controller 400 controls the overall operation of the mobile device. Specifically, the controller 400 controls an operation associated with a social data management function based on the support of an SNS according to the present invention. For example, the controller 400 determines whether the application whose execution is requested when sensing execution of the application is a social application associated with the SNS. Further, when the application is the social application, the controller determines a type of a social networking service supported from the social application. Moreover, the controller 400 connection-controls a library of a corresponding SNS in a plug-in form to provide the determined social networking service associating with the application. That is, the controller 400 integrally manages social data of an SNS used by the user through a plug-in library structure for supporting various SNSs. The controller 400 provides an SNS based on the application.

Moreover, the controller 400 collects various activity logs of the user, construct a DB with the collected activity logs of the user, and extract an interest keyword of the user (e.g., fields or genres such as camping, table tennis, classic) based on the constructed DB. Furthermore, the controller extracts a social interest keyword based on a user (e.g., content associated with users whose interest is similar or an interest keyword) based on the extracted user interest keyword and an SNS use pattern. Moreover, the controller 400 selects social content associated with an interest of the user, determine a priority such as social data of another user whose affinity is high or social data having a high preference, and provide the determined priority to an upper application. Further, the controller 400 supports the SNS subscribed by the user in a plug-in form and manage authentication information (e.g., ID and password) of each service to use user social data without a separate procedure in an execution application.

The controller 400 includes a social data management system 500 for managing social data of the present invention. The social data management system 500 includes a common characteristic processor 600 and a plug-in manager 700. The social data management system 500 will be described below. Further, as described above, the controller 400 controls the overall operation of a function of the present invention. A detailed control operation of the controller 400 will be described in an example of an operation of the mobile device and a control method thereof with reference to following drawings.

In addition to the foregoing functions, the controller 400 controls various operations associated with a typical function of the mobile device. For example, when a certain application is executed, the controller 400 controls an operation of the executed application and screen display. Further, the controller 400 receives input of various touch events supported from a touch-based input interface and controls a function operation according thereto. The controller 400 controls transmission and reception of various data based on wired communication or wireless communication.

The mobile device of the present invention illustrated in FIG. 2 includes various information communication devices and multi-media devices supporting a social networking service function and an application device thereof. For example, the mobile device includes devices such as a Personal Computer (PC), a Smartphone, a digital camera, a Portable Multimedia Player (PMP), a Media Player, a portable game terminal, and a Personal Digital Assistant (PDA) as well as a mobile communication terminal operating based on respective communication protocols corresponding to various communication systems.

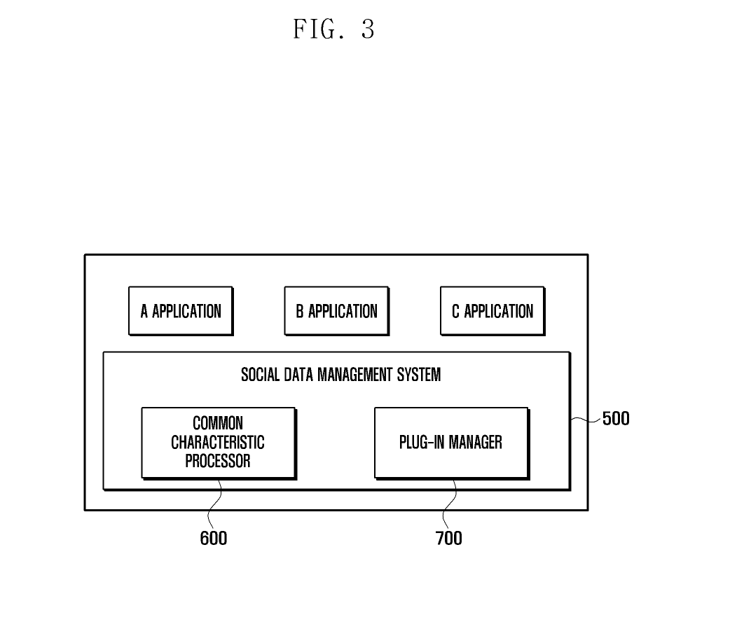

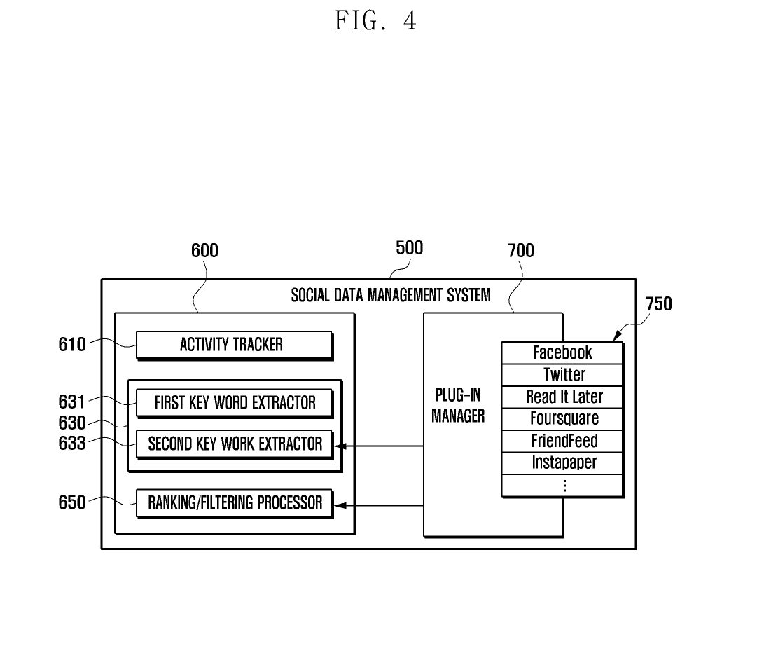

FIG. 3 is a diagram illustrating a platform structure in which a social data management system for supporting an SNS in a mobile device is mounted according to an embodiment of the present invention, and FIG. 4 is a block diagram schematically illustrating a configuration of a social data management system according to an embodiment of the present invention.

Referring to FIGS. 3 and 4, the social data management system 500 of the present invention includes a common characteristic processor 600 processing common characteristics of various SNSs and a plug-in manager 700 associating libraries 750 according to various SNSs in a plug-in form with one another. A library connection structure for supporting a corresponding SNS may be omitted from respective applications supporting an SNS by the social data management system 500.

The plug-in manager 700 manages social data of an SNS used by a user through a plug-in library structure for supporting various social networking services. Further, the plug-in manager 700 manages libraries 750 of various types of SNSs in a plug-in form. In particular, when operating an SNS according to a social application, the plug-in manager 700 provides libraries 750 corresponding to types of corresponding SNSs in a plug-in form.

For example, when a Flipboard application for supporting a magazine-based mobile SNS is operated, the plug-in manager 700 connects a Facebook library, a Twitter library, and a Read it Later library to the Flipboard application in a plug-in form associated with each server of each SNS. When a Waze application for supporting a location-based mobile SNS is operated, the plug-in manager 700 connects a Facebook library, a Twitter library, and a Foursquare library to the Waze application in a plug-in form associated with each server of each SNS. Further, when a My6sense application for supporting a search based mobile SNS is operated, the plug-in manager 700 connects a Facebook library, a Twitter library, a Friend Feed library, and an Instapaper library to the My6sense application in a plug-in form associated with each server of each SNS.

Moreover, the plug-in manager 700 provides social data associated with an SNS to a keyword extractor 630 (particularly, second keyword extractor 633) and a ranking/filtering processor 650 of the common characteristic processor 600.

The common characteristic processor 600 manages social data of various types of SNSs, extract a user interest keyword through tracking and analyzing activity of a user generated in a mobile device according to use of an SNS by the user, extract users whose interest is similar and social content based on the extracted user interest keyword an SNS use pattern of the user according to tracking the activity, and perform a series of processes automatically selecting and giving a priority to social content preferred by the user.

The common characteristic processor 600 includes an activity tracker 610, a keyword extractor 630, and a ranking/filtering processor 650. In the present invention, the keyword extractor 630 includes a first keyword extractor 631 and a second keyword extractor 633.

The activity tractor 610 tracks various activities that the user generates in the mobile device. For example, the activity tracker 610 tracks activities such as used patterns, web search keyword, web visit log and time, SMS, katalk, call, or the like with respect to various SNSs of the user which the user generates in the mobile device.

Further, when the user executes an application associated with the SNS, the activity tracker 610 tracks a user activity as mentioned above which the user generates through a corresponding application, and upgrade a DB based on the tracked activity log of the user. That is, the activity tracker 610 tracks content with respect to various activities generated as the user uses the SNS from the mobile device.

The keyword extractor 630 extracts a keyword associated with use of a networking service by the user. The keyword extractor 630 includes a first keyword extractor 631 extracting an interest keyword (first keyword) of a user based on the user activity tracked by the activity tracker 610 and a second keyword tracker 633 extracting a social interest keyword of the user (e.g., another user whose interest is different, a type of content, etc.) (second keyword) based on the extracted interest keyword of the user from the first keyword extractor 631 and a use pattern of an SNS by the user. The second keyword extractor 633 extracts the social interest keyword based on social data of the SNS provided from the plug-in manager 700.

The ranking/filtering processor 650 automatically ranks or filters and provides various social data associated with a user based on keywords (e.g., a first keyword and a second keyword) extracted by the keyword extractor 630. The ranking/filtering processor 650 processes ranking or filtering based on social data of the SNS provided from the plug-in manager 700.

As illustrated in FIG. 3, the social data management system 500 is mounted in an application program layer, and respective applications associated with the SNS by the social data management system 500 omit a connection structure of libraries of respective SNSs for associating with the SNS. Accordingly, in an embodiment of the present invention, the size of the application associated with the SNS is reduced and development is eased. Further, the embodiment of the present invention supports the SNS based on more exact user preference information (e.g., content, persons/affinity, interest keywords, and the like) through support of automatic ranking and filtering of various social data associated with the user.

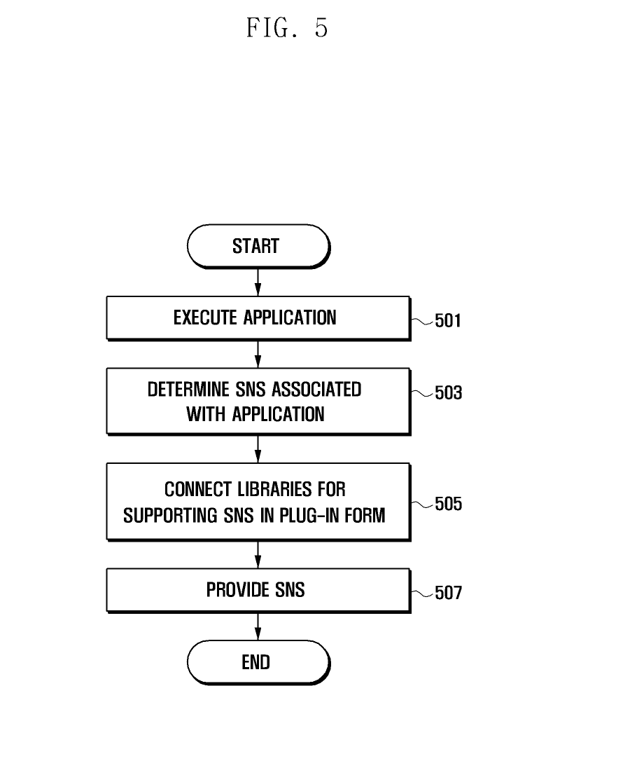

FIG. 5 is a flowchart illustrating a method for supporting an SNS of a mobile device according to an embodiment of the present invention.

Referring to FIG. 5, when sensing execution of an application in step 501, a controller 400 of a mobile device determines an SNS associated with the executed application in step 503. For example, when sensing the execution of the application from the user, the controller 400 determines whether the application whose execution is requested is a social application associated with the SNS. When the application is the social application, the controller 400 determines a type of the SNS supported from the social application.

The controller 400 connects libraries for supporting the SNS in a plug-in form based on the application in step 505. For example, when determining a type of the SNS, the controller 400 connects libraries of a corresponding SNS in a plug-in form to provide the determined SNS associated with the application. That is, the controller 400 manages social data of the SNS used by the user through a plug-in library structure for supporting various SNSs.

The controller 400 then provides an SNS based on the application in step 507. For example, the controller 400 controls screen output of social content provided from the SNS through the execution of the application. Further, the controller 400 controls function processing by user input from the output screen.

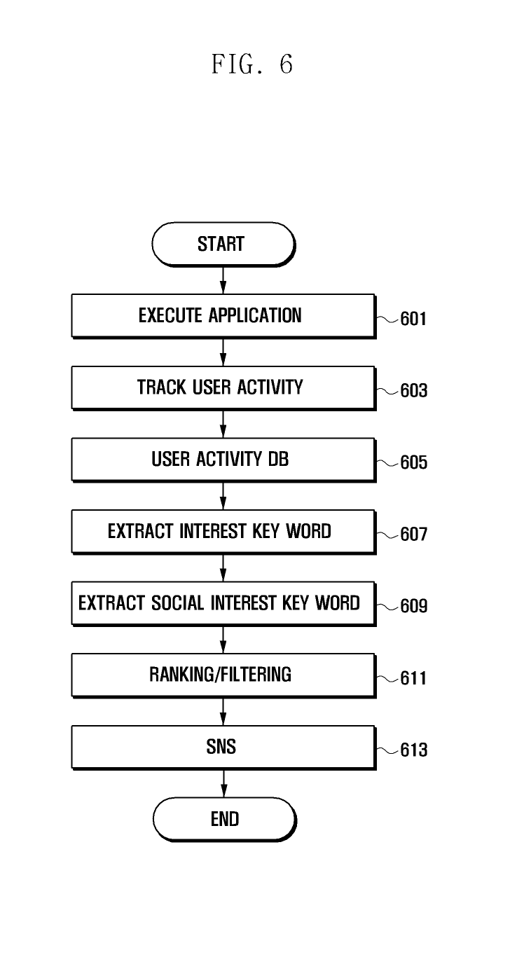

FIG. 6 is a flowchart illustrating a method for managing social data of a mobile device according to an embodiment of the present invention.

Referring to FIG. 6, when sensing execution of an application in step 601, a controller 400 of a mobile device tracks a user activity in step 603. Next, the controller 400 may construct a DB based on the tracked user activity in step 605. For example, when the user executes an application (e.g., Flipboard application) associated with the SNS, the controller 400 tracks various activities (e.g., various SNS use patterns, web search keyword, web visit log and time) and upgrade a DB based on the tracked activity log of the user.

The controller 400 then extracts an interest keyword of a user with reference to the constructed DB based on the user activity in step 607. For example, the controller 400 extracts interest keywords such as used field or genre through the SNS such as camping, table tennis, or classical music based on the user activity.

The controller 400 then extracts the primary keywords and then extracts a user centered social interest keyword of the user in step 609. In this case, the controller 400 extracts the user centered social interest keyword based on the extracted primary key and a use pattern with respect to the SNS from the constructed DB. For example, the controller 400 also extracts another user having a similar interest to that of the user and a social interest keyword such as content associated with the interest keyword based on the primary keyword and the SNS use pattern.

The controller 400 automatically ranks and filters social data of various SNSs associated with a user based on the extracted social interest keyword in step 611. For example, the controller 400 selects content associated with an interest of the user, and determines a priority of social data of another user having high affinity or social data having high preference and transfer the priority to the application layer. Subsequently, the controller 400 provides the user centered SNS through the application in step 613. For example, when providing the SNS associated with the application, the controller 400 supports screen output configured based on social data preferred by the user.

As described above, in an embodiment of the present invention, social data with various SNSs are managed based on a mobile platform through a social data management system 500 in the mobile device. Accordingly, when developing an application associate with the SNS, a developer can concentrate on an algorithm and a function of a corresponding application without considering library connection of the SNS to be connected in a corresponding application to the application. The developed application is combined with a library of each SNS provided in a plug-in form from the mobile device to support the SNS. In the present invention, because an SNS of a user is managed in a mobile platform itself, it is easy to develop an application using social data, and accordingly the size of the application may be reduced. Further, an application developer may perform automatic ranking and filtering of social data preferred by a mobile device user to display a screen based on social data preferred by the user.

The social data management system and a method for operating the same of the present invention is implemented in an executable program command form by various computer means and be recorded in a computer readable recording medium. The computer readable recording medium includes a program command, a data file, and a data structure individually or a combination thereof. The program command recorded in a recording medium is specially designed or configured for the present invention.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a complier and a high-level language code executable by a computer using an interpreter. The foregoing hardware device may be configured to be operated as at least one software module to perform an operation of the present invention, and vice versa.

As described above, in the social data management system and a method for operating the same according to the present invention, a mobile device processes various social data according to various social networking services. In the present invention, common characteristics of various SNSs are provided from a mobile platform, and automatic ranking or filtering with respect to social data preferred by the user may be supported. The present invention manages social data with respect to various SNSs based on a mobile platform through a social data management system in a mobile device.

Since common characteristics of various SNSs are provided from a mobile platform itself, the size of an application processing social data may be reduced. Because an application developer uses only a social API of a mobile platform, development is simpler. That is, when developing an application for the SNS, the application developer can concentrate and develop a design implementing a corresponding application and a design approaching hardware of a mobile device and social data through an API in a corresponding application without considering a design for library association according the SNS. The present invention supports automatic ranking or filtering of social data based on user preference information to display based on social data preferred by the user by calling only social API provided from a mobile platform in the application. Accordingly, when the user uses the SNS, social content based on exact user preference information (e.g., persons, affinity, interest keywords, and the like) is displayed. That is, because the present invention manages an SNS of the user in a mobile platform itself, it is easy to develop an application using social data. Although the application developer does not perform separate processing, automatic ranking or filtering processing of social data preferred by the user is possible.

The present may be implemented in various forms of a mobile device and various devices corresponding thereto. Furthermore, the present invention develops an application of an SNS in a mobile device and implements an optimal environment for social data management of a mobile device to improve ease of application development, utilization, convenience, and competitive force of the mobile device.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. A system for supporting a social networking service, the system comprising:
a plug-in manager for managing social data of the social networking service used by a user through a plug-in library structure; and
a common characteristic processor for tracking an activity of the user based on use of an SNS of the user to extract a user interest keyword, extracting another user whose interest is similar and social contents, and automatically selecting social content preferred by the user, and giving a priority to the selected social contents.

2. The system of claim 1, wherein the common characteristic processor comprises:
an activity tracker for tracking activities that the user generates in a mobile device;
a keyword extractor for extracting a keyword associated with use of a networking service by the user; and
a ranking/filtering processor for automatically ranking or filtering a plurality of social data associated with the user based on the tracked keyword from the keyword extractor.

3. The system of claim 2, wherein the activity tracker tracks content relating to all actions generated based on use of an SNS in the mobile device by the user.

4. The system of claim 2, wherein the keyword extractor comprises:
a first keyword extractor extracting an interest keyword of the user based on the activity of the user tracked by the activity tracker; and
a second keyword extractor extracting a user centered social interest keyword based on the interest keyword of the user extracted from the first keyword extractor and a use pattern of a social networking service of the user.

5. A method for supporting a social networking service, the method comprising:
determining the social networking service associated with an application when execution of the application is sensed;
connecting libraries for supporting the social networking service in a plug-in form based on the application; and
providing the social networking service based on the application.

6. The method of claim 5, wherein determining the social networking service comprises:
determining whether the application is a social application associated with the social networking service when execution of an application is sensed; and
determining a type of a social networking service supported from the social application when the application is a social application.

7. The method of claim 5, wherein providing the social networking service comprises providing social data of a social networking service used by the user through a plug-in library for supporting a corresponding social networking service when the type of the social networking service is determined.

8. A method for supporting a social networking service, the method comprising:
tracking a user activity when execution of an application is sensed from a user;
extracting an interest keyword of the user;
automatically ranking or filtering social data of social networking services associated with the user based on the extracted interest keyword; and
providing the social networking service through the application.

9. The method of claim 8, wherein tracking the user activity comprises creating a database based on the tracked user activity.

10. The method of claim 9, wherein tracking the user activity comprises:
tracking a plurality of social networking service use patterns, a web search keyword, and a web visit log and time generated by the user through a corresponding application when the user executes an application associated with the social networking service; and
updating the database based on the tracked activity of the user.

11. The method of claim 8, wherein extracting the interest keyword comprises:
extracting the interest keyword of the user based on the user activity; and
extracting the interest keyword and extracting a user centered social interest key word.

12. The method of claim 11, wherein extracting the social interest keyword comprises extracting a social interest keyword of the user based on the interest keyword and a use pattern with respect to a social networking service of the user.

13. The method of claim 12, wherein the interest keyword indicates a keyword corresponding to a field and a genre that the user uses through a social networking service based on the user activity, and the social interest keyword indicates a keyword corresponding to another user having a different interest from that of the user and content associated with the interest key word.

14. The method of claim 8, wherein automatically ranking or filtering the social data comprises determining a priority with respect to social data associated with the interest key word.

15. The method of claim 14, wherein providing the social networking service comprises outputting a social networking service screen configured based on social data of the determined priority when a social networking service associated with the application is provided.
